(19) United States
(12) Patent Application Publication
(10) Pub. No.: US 2003/0085326 A1
(43) Pub. Date: May 8, 2003

(54) Bracket

(75) Inventors: Chad A. Simonson, Madison, MN (US); Robert L. Claussen, Benson, MN (US)

Correspondence Address: William L. Huebsch, 1494 W. Iowa Ave., St. Paul, MN, 55108, US

(73) Assignee: REDBALL, LLC

(21) Appl. No.: 10/012,738

(22) Filed: Nov. 5, 2001

(51) Int. Cl. F16L 3/00

(52) U.S. Cl. 248/51; 248/49

(57) ABSTRACT

A bracket for securing an end portion of a flexible agricultural chemical delivery tube along an end portion of an elongate rigid seed tube on a planter. The elongate bracket has a rear surface adapted to be positioned along and in contact with the front surface of the seed tube, and has a longitudinally extending row of sockets opening through its rear surface that are adapted to receive protrusions projecting above the front surface of the seed tube. The sockets are defined by surfaces adapted to engage those protrusions to retain the position of the bracket along the front surface of the seed tube. Along a front surface of the bracket are members adapted to receive and retain the end portion of the flexible chemical delivery tube.

### FIELD OF THE INVENTION

This invention concerns structures by which the outlet end portions of tubes through which agricultural chemicals (e.g., fertilizers or weed killers) may be fed can be positioned adjacent outlet ends of seed tubes on a planter so that the chemicals can be deposited closely adjacent seeds planted through the seed tubes.

### BACKGROUND OF THE INVENTION

It is often desirable to apply agricultural chemicals (e.g., fertilizers, insecticides, or weed killers) around seeds at the time that they are planted. Selective application of chemicals closely around planted seeds is made difficult, however, because many seed planters currently in use open a furrow in the ground, drop seeds to the bottom of those open furrows through a row of spaced rigid seed tubes depending from the planter, and then close the furrows over the seeds as the planter moves over the field being planted. Thus, the chemicals must be applied in the open furrows if they are to be positioned closely around the planted seeds. Chemical application systems have been used that are mounted on a planter and include an array of rigid tubes extending from a manifold, each of which rigid tubes has an end positioned adjacent the outlet end of a seed tube between that seed tube and double disc openers on the planter that open a furrow for that seed tube so that agricultural chemicals can be delivered through that rigid tube into the furrow opened for that seed tube. Such a system, however, is expensive to build and the rigid tubes can be bent by contact with the ground or foreign objects along the ground so that they no longer deliver the chemicals within the furrow.

### DISCLOSURE OF THE INVENTION

The present invention provides a simple inexpensive bracket that allows agricultural chemicals to be delivered through a flexible tube into an open furrow closely around seeds being planted by a planter of the type described above, while insuring that the outlet end of the flexible tube remains in a position closely adjacent the outlet end of the seed tube.

The bracket according to the present invention is adapted for securing an end portion of the flexible agricultural chemical delivery tube along an end portion of the elongate rigid seed tube on the planter through which tube seeds are directed into the ground over which the planter is moved, that seed tube having (as is typical of such seed tubes) an upper end portion attached to a frame of the planter, an opposite depending lower end, and a downwardly extending front surface above which surface project a plurality of longitudinally spaced transversely centered protrusions. Each protrusion typically includes opposing arcuate projections from adjacent edge portions of a stiff polymeric sheet that is formed into the seed tube, and a rivet holding those projections together, thereby securing together those adjacent edge portions of the seed tube. The bracket is elongate, has longitudinally spaced upper and lower ends, has a rear surface that is adapted to be positioned along and in contact with the front surface of the seed tube. The bracket has surfaces defining a longitudinally extending row of sockets opening through its rear surface generally centrally between its opposite edges, which sockets are adapted to receive the protrusions from the seed tube. The surfaces defining the sockets are adapted to engage side surfaces of those protrusions to insure that the bracket remains positioned along the front surface of the seed tube. The bracket also includes members along a front surface opposite its rear surface that are adapted to receive and retain the end portion of the chemical delivery tube with that chemical delivery tube extending longitudinally along the front surface and its end positioned adjacent the lower end of the bracket.

Thus this bracket allows the agricultural chemicals to be delivered through a flexible chemical delivery tube that is less expensive and more easily mounted on the planter than the system using rigid metal chemical delivery tubes described above, reliably places the outlet end portion of that chemical delivery tube in the furrow into which the seeds are dropped, and protects the flexible chemical delivery tube from damaging contact with the ground or other structures external to the planter.

### BRIEF DESCRIPTION OF THE DRAWINGS

The present invention will be further described with reference to the accompanying drawing wherein, like parts are identified with like reference numerals in the several views, and wherein:

FIG. 1 is a perspective view of a bracket according to the present invention shown attaching an end portion of a flexible chemical delivery tube to a rigid seed tube of a planter;

FIG. 2 is an enlarged fragmentary side view showing the bracket of FIG. 1 securing the chemical delivery to the seed tube of the planter;

FIG. 3 is an enlarged perspective view of the bracket of FIG. 1; and

FIG. 4 an enlarged rear view of the bracket of FIG. 1.

### DETAILED DESCRIPTION OF THE INVENTION

Referring now to the drawing, there is shown a bracket according to the present invention generally designated by the reference numeral 10.

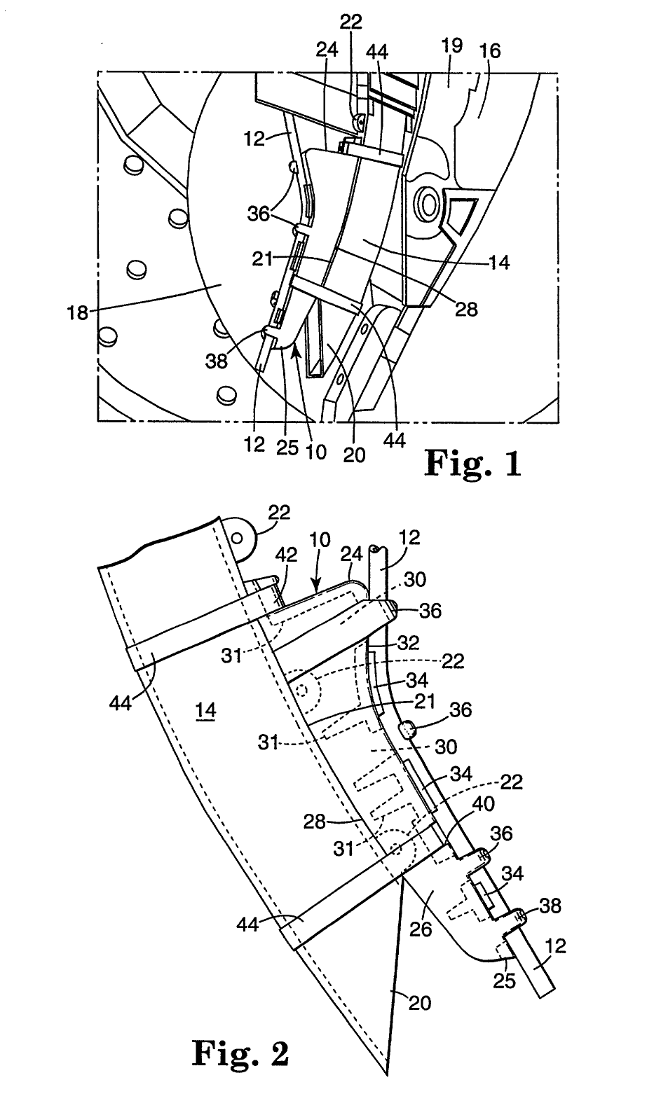

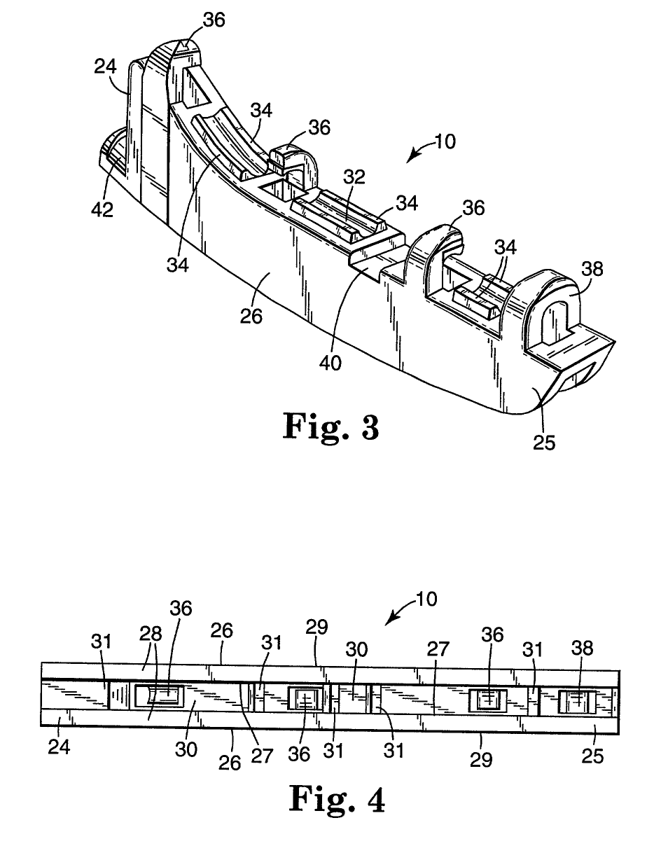

As is seen in FIGS. 1 and 2, the bracket 10 is adapted for securing an end portion of a flexible polymeric agricultural chemical delivery tube 12 (e.g., ¼ inch or 0.64 cm O.D., 3/16 inch or 0.48 cm I.D. “Polytemp” tubing) along an end portion of an elongate rigid seed tube 14 on a planter 16 (e.g., a 2000 series through 3000 series planter made by Kinize Manufacturing , Inc., Williamsburg, Iowa that is illustrated in FIG. 1; a 7000 Series through 1700 series planter made by John Deer, Moline, Ill., or a 6000 series “White” planter made by Agco Corporation, Duluth, Ga.). Agricultural chemicals (e.g., fertilizers, insecticides, or weed killers) may be fed through the chemical delivery tube 12 from a conventional chemical delivery system (not shown) mounted on the planter 16. The planter 16 is of the known type that has a row of the seed tubes 14 through which seeds are planted, has double disk openers 18 that open a furrow in the ground for each of the seed tubes 14, drops seeds to the bottom of the open furrows through the seed tubes 14, and then closes the furrows with closing wheels (not illustrated) as the planter moves over the field being planted. Each seed tube 14 has an upper end portion attached to the frame 19 of the planter 16, an opposite depending lower end 20, and a downwardly extending front surface 21 that is generally cylindrically concave about a transverse axis. Above the front surface 21 of the seed tube 14 project a plurality of longitudinally spaced transversely centered protrusions 22. Each protrusion 22 typically includes opposing arcuate projections from adjacent edge portions of a stiff polymeric sheet that is formed into the seed tube, and a rivet holding those projections together, thereby securing together those adjacent edge portions of the seed tube 14.

The bracket 10 is elongate, has longitudinally spaced upper and lower ends 24 and 25, has transversely spaced side walls 26 extending between its ends 24 and 25, and has a rear surface 28 having opposite edges 29 extending between its ends 24 and 25, which rear surface 28 is defined by spaced edge surfaces of the side walls 26. The rear surface 28 of the bracket 10 is generally cylindrically convex about a transverse axis, and is adapted to be positioned along and in contact with the front surface 21 of the seed tube 14. The bracket 10 has a longitudinally extending row of sockets 30 opening through its rear surface 28 generally centrally between the edges of the rear surface 28, which sockets 30 are adapted to receive the protrusions 22. The sockets 30 are defined by surfaces of the bracket 10 including opposed inner surfaces 27 of the side walls and the side surfaces of a spaced retaining walls 31 extending transversely between the spaced side walls 26. The surfaces defining the sockets 30 are adapted to engage side surfaces of the protrusions 22 projecting above the front surface 21 of the seed tube 14 to insure that the bracket 10 will not become displaced from its position along the front surface 21 of the seed tube 14.

The bracket 10 has a front surface 32 opposite its rear surface 28, and includes members along its front surface 32 adapted to receive and retain the end portion of the chemical delivery tube 12 with the chemical delivery tube 12 extending longitudinally along the front surface 32 of the bracket 10 and an end of the chemical delivery tube 12 positioned adjacent and projecting past the lower end 25 of the bracket 10.

The members along its front surface 32 adapted to receive and retain the end portion of the chemical delivery tube 12 comprise transversely spaced longitudinally extending ribs 34 defining a channel between the ribs 34 in which a side portion of the chemical delivery tube 12 can be received, and three longitudinally spaced outwardly projecting hook shaped members 36 opening alternately in opposite directions, under which hook shaped members 36 the end portion of the chemical delivery tube 12 may be closely engaged to retain the chemical delivery tube 12 in the channel between the ribs 34. At the lower 25 of the bracket is an outwardly projecting loop 38 that will closely receive the chemical delivery tube 12 adjacent its end to position that end adjacent the lower end 25 of the bracket 10. The hook shaped members 36 and the loop 38 are adapted to slightly compress the flexible chemical delivery tube 12, and keep the delivery tube 12 from sliding longitudinally along the channel. The front surface 32 adjacent the lower end 25 of the bracket 10 is generally parallel to its rear surface 28, but adjacent the upper end 24 of the bracket a portion of its front surface 32 diverges away from its rear surface 28 so that the divergent portion of its front surface 32 is disposed at about an 130 degree angle with respect to the portion of its front surface 28 that is about parallel to its rear surface 28. This shape of the front surface 32 causes an arc of about 30 degrees in the somewhat resiliently flexible chemical delivery tube 12 which directs the delivery tube smoothly into the bracket 10 and may also help to retain the chemical delivery tube 12 in the channel defined by the ribs 34 and under the hook shaped members 36 along the front surface 32.

The bracket 10 has transversely extending grooves, including a groove 40 across the front surface 32 recessed from the channel for the tube 12 defined by the ribs 34 at about two thirds the distance from the upper end 24 to the lower end 25 of the bracket 10, and a groove 42 across a semi-cylindrical projection at the upper end 24 of the bracket 10. The grooves 40 and 42 can receive and retained tie straps 44 (e.g., metal or plastic tie straps) extending around both the bracket 10 and the seed tube 14 to secure the rear surface 28 of the bracket 10 against the front surface 21 of the seed tube 14. When thus secured n the seed tube 14 by the tie straps 44, the bracket 10 will be located and restricted from sliding along the front surface 21 of the seed tube 14 by the protrusions 22 being positioned in the sockets 30 defined by the surfaces of the bracket 10 (i.e., defined by the inner surfaces of the side walls 26 and the side surfaces of the retaining walls 31).

The bracket 10 is injection molded from a rigid polymeric material (e.g., a polyolefin), and, as an example, can have a width of about ¾ inch or 1.9 cm between the outer surfaces of its side walls 26, a length between its upper and lower ends 24 and 25 of about 6.75 inches or 17.15 cm, a thickness between its front and rear surfaces 32 and 28 midway between its upper and lower ends 24 and 25 of about ⅞ inch or 2.22 cm, side wall 26 thicknesses of about 3/16 inch or 0.48 cm, and a rear surface 28 radius of about of about 18 inches or 45.7 cm.

The present invention has now been described with reference to one embodiment. It will be apparent to those skilled in the art that many changes can be made in the embodiment described without departing from the scope of the present invention. Thus, the scope of the present invention should not be limited to the structure described in this application, but only by the structures described by the language of the claims and the equivalents thereof.

What is claimed is:

1. A bracket for securing an end portion of a flexible agricultural chemical delivery tube along an end portion of an elongate rigid seed delivery tube on a planter, said seed tube having an upper end portion attached to a frame of the planter, an opposite depending lower end, and a downwardly extending front surface above which surface project a plurality of longitudinally spaced transversely centered protrusions, said bracket
being elongate,
having longitudinally spaced upper and lower ends,
having a rear surface, said rear surface having opposite edges extending between said ends of the bracket, and being adapted to be positioned along and in contact with the front surface of the seed tube
having a longitudinally extending row of sockets opening through said rear surface generally centrally between said edges, said sockets being adapted to receive the protrusions projecting above the front surface of the seed tube, and being defined by surfaces of the bracket adapted to engage the protrusions projecting above the front surface of the seed tube to retain the position of the bracket along the front surface of the seed tube,
having a front surface opposite said rear surface, and
including members along said front surface adapted to receive and retain the end portion of the chemical delivery tube with the chemical delivery tube extending longitudinally along the front surface and an end of the chemical delivery tube positioned adjacent the lower end of the bracket.

2. A bracket according to claim 1 wherein said members along said front surface adapted to receive and retain the end portion of the chemical delivery tube comprise transversely spaced longitudinally extending ribs defining a channel between the ribs in which a side portion of the chemical delivery tube can be received, and a plurality of longitudinally spaced outwardly projecting hook shaped members under which the end portion of the chemical delivery tube can be engaged to retain the chemical delivery tube in the channel between the ribs.

3. A bracket according to claim 2 wherein said members along said front surface adapted to receive and retain the end portion of the chemical delivery tube further comprise an outwardly projecting loop at the lower end of the bracket that will closely receive the chemical delivery tube adjacent the end of the chemical delivery tube to position that end of the chemical delivery tube adjacent the lower end of the bracket.

4. A bracket according to claim 2 wherein said front surface adjacent the lower end of the bracket is generally parallel to said rear surface, and adjacent the upper end of the bracket said front surface diverges away from said rear surface to cause an arc in the flexible chemical delivery tube.

5. A bracket according to claim 2 further having transversely extending grooves, including a groove across said front surface recessed from the channel for the chemical delivery tube defined by said ribs, and a groove across a semi-cylindrical projection at the upper end of the bracket, said grooves being adapted to receive and retained tie straps extending around both the bracket and the seed tube to secure the rear surface of the bracket against the front surface of the seed tube with the bracket being located and restricted from sliding along the front surface of the seed tube by engagement of one or more of the protrusions with surfaces of the bracket defining one or more of the sockets.

6. In combination,
an elongate rigid seed tube on a planter through which seed tube seeds may be directed into the ground over which the planter is moved, said seed tube having an upper end portion attached to a frame of the planter, an opposite lower end, and a downwardly extending front surface above which front surface project a plurality of longitudinally spaced transversely centered protrusions;
a flexible chemical delivery tube through which agricultural chemicals may be fed by a chemical delivery system on the planter;
a bracket for securing an end portion of the chemical delivery tube along an end portion of the seed tube, said bracket
being elongate,
having longitudinally spaced upper and lower ends,
having a rear surface, said rear surface having opposite edges extending between said ends, being generally cylindrically convex about a transverse axis, and being positioned along and in contact with the front surface of the seed tube,
having a longitudinally extending row of sockets defined by surfaces of the bracket, opening through said rear surface generally centrally between said edges, and receiving said protrusions, at least one of the surfaces defining said sockets being positioned to engaging at least one of the protrusions projecting above the front surface of the seed tube to position the bracket longitudinally along the front surface of the seed tube,
having a front surface opposite said rear surface, and
including members along said front surface receiving and retaining the end portion of the chemical delivery tube with the chemical delivery tube extending longitudinally along the front surface and an end of the chemical delivery tube positioned adjacent the lower end of the bracket; and
a plurality of straps around the bracket and seed tube securing the rear surface portions of the side walls against the front surface of the seed tube.

7. A combination according to claim 6 wherein said members along said front surface receiving and retaining the end portion of the chemical delivery tube comprise transversely spaced longitudinally extending ribs defining a channel between the ribs in which a side portion of the chemical delivery tube is received, and a plurality of longitudinally spaced outwardly projecting hook shaped members under which the end portion of the chemical delivery tube is engaged to retain the chemical delivery tube in the channel between the ribs.

8. A combination according to claim 7 wherein said members along said front surface receiving and retaining the end portion of the chemical delivery tube further comprise an outwardly projecting loop at the lower end of the bracket closely receiving the chemical delivery tube adjacent the end of the chemical delivery tube to position that end of the chemical delivery tube adjacent the lower end of the bracket.

9. A combination according to claim 7 wherein said front surface of the bracket adjacent the lower end of the bracket is generally parallel to said rear surface of the bracket, and adjacent the upper end of the bracket the front surface of the bracket diverges away from said rear surface to cause an arc in the chemical delivery tube.

10. A combination according to claim 7 further having transversely extending grooves, including a groove across said front surface of the bracket recessed from the channel for the chemical delivery tube defined by said ribs, and a groove across a semi-cylindrical projection at the upper end of the bracket, said grooves receiving and retaining the tie straps extending around both the bracket and the seed tube to secure the rear surface of the bracket against the front surface of the seed tube.

11. A combination according to claim 6 wherein the front surface of said seed tube is generally cylindrically concave about a transverse axis, and the rear surface of said bracket is generally cylindrically convex about a transverse axis.

12. A bracket for securing an end portion of a flexible agricultural chemical delivery tube along an end portion of an elongate rigid seed delivery tube on a planter, said seed tube having an upper end portion attached to a frame of the planter, an opposite depending lower end, and a cylindrically concave downwardly extending front surface above which surface project a plurality of longitudinally spaced transversely centered protrusions, said bracket
being elongate,
having longitudinally spaced upper and lower ends,
having a rear surface, said rear surface having opposite edges extending between said ends of the bracket, being generally cylindrically convex about a transverse axis, and being adapted to be positioned along and in contact with the front surface of the seed tube
having a longitudinally extending row of sockets opening through said rear surface generally centrally between said edges, said sockets being adapted to receive the protrusions projecting above the front surface of the seed tube, and being defined by surfaces of the bracket adapted to engage the protrusions projecting above the front surface of the seed tube to retain the position of the bracket along the front surface of the seed tube,
having a front surface opposite said rear surface, and
including members along said front surface adapted to receive and retain the end portion of the chemical delivery tube with the chemical delivery tube extending longitudinally along the front surface and an end of the chemical delivery tube positioned adjacent the lower end of the bracket

13. A bracket according to claim 12 wherein said members along said front surface adapted to receive and retain the end portion of the chemical delivery tube comprise transversely spaced longitudinally extending ribs defining a channel between the ribs in which a side portion of the chemical delivery tube can be received, and a plurality of longitudinally spaced outwardly projecting hook shaped members under which the end portion of the chemical delivery tube can be engaged to retain the chemical delivery tube in the channel between the ribs.

14. A bracket according to claim 13 wherein said members along said front surface adapted to receive and retain the end portion of the chemical delivery tube further comprise an outwardly projecting loop at the lower end of the bracket that will closely receive the chemical delivery tube adjacent the end of the chemical delivery tube to position that end of the chemical delivery tube adjacent the lower end of the bracket.

15. A bracket according to claim 13 wherein said front surface adjacent the lower end of the bracket is generally parallel to said rear surface, and adjacent the upper end of the bracket said front surface diverges away from said rear surface to cause an arc in the flexible chemical delivery tube.

16. A bracket according to claim 13 further having transversely extending grooves, including a groove across said front surface recessed from the channel for the chemical delivery tube defined by said ribs, and a groove across a semi-cylindrical projection at the upper end of the bracket, said grooves being adapted to receive and retained tie straps extending around both the bracket and the seed tube to secure the rear surface of the bracket against the front surface of the seed tube with the bracket being located and restricted from sliding along the front surface of the seed tube by engagement of one or more of the protrusions with surfaces of the bracket defining one or more of the sockets.
